(19) United States
(12) Patent Application Publication
(10) Pub. No.: US 2023/0079288 A1
(43) Pub. Date: Mar. 16, 2023

(54) NONAQUEOUS ELECTROLYTE SECONDARY BATTERY AND ELECTRODE FOR NONAQUEOUS ELECTROLYTE SECONDARY BATTERIES

(71) Applicant: SANYO Electric Co., Ltd., Kadoma-shi, Osaka (JP)

(72) Inventors: Shigeki Moriya, Osaka (JP); Nobuhiro Sakitani, Tokushima (JP); Takaharu Morikawa, Osaka (JP)

(73) Assignee: SANYO Electric Co., Ltd., Kadoma-shi, Osaka (JP)

(21) Appl. No.: 17/799,138

(22) PCT Filed: Feb. 17, 2021
(86) PCT No.: PCT/JP2021/005822

§ 371 Date: Aug. 11, 2022

(30) Foreign Application Priority Data
Feb. 19, 2020 (JP) 2020-026499

(51) Int. Cl. H01M 4/36; H01M 10/0569; H01M 4/04; H01M 4/62; H01M 10/04; H01M 10/052; H01M 4/48

(52) U.S. Cl. CPC H01M 4/366; H01M 10/0569; H01M 4/0404; H01M 4/364; H01M 4/622; H01M 10/0468; H01M 10/052; H01M 4/48; H01M 2004/027

(57) ABSTRACT

A nonaqueous electrolyte secondary battery according to one embodiment of the present disclosure is provided with a wound-type electrode body. A negative electrode has: a negative electrode collector; and negative electrode mixture layers that are formed on both lateral surfaces of the negative electrode collector, while containing at least a negative electrode active material and a binder. The negative electrode mixture layers include an inner negative electrode mixture layer that is positioned on the inner circumference side of the negative electrode collector and an outer negative electrode mixture layer that is positioned on the outer circumference side. The swelling degree of the binder contained in the outer negative electrode mixture layer is higher than the swelling degree of the binder contained in the inner negative electrode mixture layer; and the outer negative electrode mixture layer contains a binder that has a swelling degree of from 150% to 250%.

### TECHNICAL FIELD

The present disclosure relates to a non-aqueous electrolyte secondary battery and a negative electrode for a non-aqueous electrolyte secondary battery.

### BACKGROUND ART

Conventionally widely used is a non-aqueous electrolyte secondary battery comprising: a wound electrode assembly in which a band-shaped positive electrode and a band-shaped negative electrode are wound with a separator interposed therebetween; and an exterior housing body that houses the electrode assembly. The electrodes in the electrode assembly (the positive electrode and the negative electrode) have a mixture layer including an active material and a resin binder on both surfaces of each metallic current collector, and by winding the electrode assembly, cracking may occur on the mixture layer to cause peeling of the mixture layer from the current collector. In particular, a large stress is applied on the mixture layer on the inner peripheral side during the winding, leading to peeling of the mixture layer from the current collector.

Patent Literature 1 discloses that increasing a content rate of a binder included in a mixture layer closer to the center of a current collector inhibits the peeling of the mixture layer on the inner peripheral side of the current collector.

### CITATION LIST

### Patent Literatures

Patent Literature 1: Japanese Unexamined Patent Application Publication No. Hei8-17472

Patent Literature 2: Japanese Unexamined Patent Application Publication No. 2012-182012

### SUMMARY

### Technical Problem

During the winding of the electrode assembly, the inner mixture layer is compressed, and the outer mixture layer is elongated. Thus, a passage for an electrolyte liquid shrinks in the inner mixture layer to lower dispersity of Li ions. Meanwhile, on the outer side, cracking occurs and peeling due to expansion and contraction with charge and discharge tends to occur, leading to lowering of cycle characteristics.

The present disclosure provides a non-aqueous electrolyte secondary battery that inhibits the cracking and peeling of the mixture layer and that has good cycle characteristics by regulating the degree of swelling of a binder included in the mixture layer.

### Solution to Problem

A non-aqueous electrolyte secondary battery of an aspect of the present disclosure is a non-aqueous electrolyte secondary battery, comprising: an electrode assembly in which a band-shaped positive electrode and a band-shaped negative electrode are wound with a separator interposed therebetween; and an exterior housing body that houses the electrode assembly, wherein the negative electrode has a negative electrode current collector, and a negative electrode mixture layer formed on both side surfaces of the negative electrode current collector and including at least a negative electrode active material and a binder, the negative electrode mixture layer has an outer negative electrode mixture layer positioned on an outer peripheral side of the negative electrode current collector, and an inner negative electrode mixture layer positioned on an inner peripheral side of the negative electrode current collector, a degree of swelling of the binder included in the outer negative electrode mixture layer is higher than a degree of swelling of the binder included in the inner negative electrode mixture layer, and the outer negative electrode mixture layer includes a binder having a degree of swelling of 150 to 250%.

### ADVANTAGEOUS EFFECT OF INVENTION

With the non-aqueous electrolyte secondary battery according to the present disclosure, an electrode reaction on the inner negative electrode mixture layer can be uniform and peeling of the outer negative electrode mixture layer can be prevented, and therefore the cycle characteristics can be improved.

### BRIEF DESCRIPTION OF DRAWINGS

FIG. 1 is an axial sectional view of a cylindrical secondary battery of an example of an embodiment.

FIG. 2 is a perspective view of an electrode assembly comprised in the secondary battery illustrated in FIG. 1.

FIG. 3 is a front view illustrating a positive electrode and negative electrode constituting an electrode assembly of an example of an embodiment with an unwound state.

FIG. 4 is a radial sectional view of a negative electrode in an electrode assembly of an example of an embodiment.

FIG. 5 is a partially enlarged view of a radial cross section of a negative electrode in an electrode assembly of an example of an embodiment.

### DESCRIPTION OF EMBODIMENTS

Hereinafter, an example of an embodiment of a cylindrical, wound non-aqueous electrolyte secondary battery according to the present disclosure will be described in detail with reference to the drawings. In the following description, specific shapes, materials, values, directions, and the like, which are examples for facilitating understanding of the present invention, may be appropriately modified with specifications of cylindrical secondary batteries. When a plurality of embodiments and modified examples are included in the following description, use in appropriate combination of characteristic portions thereof are anticipated in advance.

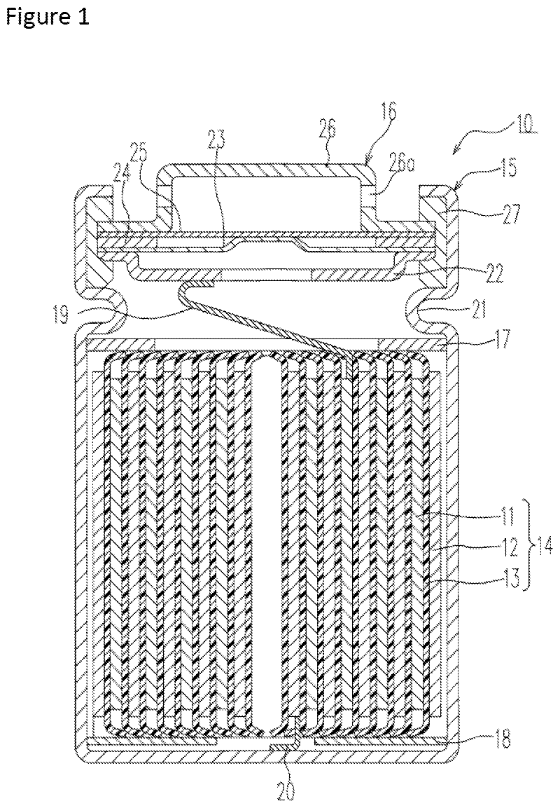

FIG. 1 is an axial sectional view of a wound secondary battery 10 of an example of an embodiment. In the secondary battery 10 illustrated in FIG. 1, an electrode assembly 14 and a non-aqueous electrolyte (not illustrated) are housed in an exterior housing body 15. The electrode assembly 14 has a wound structure in which a positive electrode 11 and a negative electrode 12 are wound with a separator 13 interposed therebetween. Although the secondary battery 10 illustrated in FIG. 1 has a cylindrical shape, the secondary battery 10 may have a rectangular shape or the like as long as the electrode assembly 14 has the wound structure. For a non-aqueous solvent of the non-aqueous electrolyte (organic solvent), carbonates, lactones, ethers, ketones, esters, and the like may be used, and two or more of these solvents may be mixed to be used. When two or more of the solvent are mixed to be used, a mixed solvent including a cyclic carbonate and a chain carbonate is preferably used. For example, ethylene carbonate (EC), propylene carbonate (PC), butylene carbonate (BC), and the like may be used as the cyclic carbonate, and dimethyl carbonate (DMC), ethyl methyl carbonate (EMC), diethyl carbonate (DEC), and the like may be used as the chain carbonate. For an electrolyte salt in the non-aqueous electrolyte, LiPF₆, LiBF₄, LiCF₃SO₃, and the like, and a mixture thereof may be used. An amount of the electrolyte salt dissolved in the non-aqueous solvent may be, for example, 0.5 to 2.0 mol/L. Hereinafter, for convenience of description, the sealing assembly 16 side will be described as “the upper side”, and the bottom side of the exterior housing body 15 will be described as “the lower side”.

An opening end of the exterior housing body 15 is capped with the sealing assembly 16 to seal inside the secondary battery 10. Insulating plates 17 and 18 are provided on the upper and lower sides of the electrode assembly 14, respectively. A positive electrode lead 19 extends upward through a through hole of the insulating plate 17, and welded with the lower face of a filter 22, which is a bottom plate of the sealing assembly 16. In the secondary battery 10, a cap 26, which is a top plate of the sealing assembly 16 electrically connected to the filter 22, becomes a positive electrode terminal. Meanwhile, a negative electrode lead 20 extends through a through hole of the insulating plate 18 toward the bottom side of the exterior housing body 15, and welded with a bottom inner face of the exterior housing body 15. In the secondary battery 10, the exterior housing body 15 becomes a negative electrode terminal. When the negative electrode lead 20 is provided on the terminal end part, the negative electrode lead 20 extends through an outside of the insulating plate 18 toward the bottom side of the exterior housing body 15, and welded with a bottom inner face of the exterior housing body 15.

The exterior housing body 15 is, for example, a bottomed cylindrical metallic exterior housing can. A gasket 27 is provided between the exterior housing body 15 and the sealing assembly 16 to electrically insulate both the member, and to achieve sealability inside the secondary battery 10. The exterior housing body 15 has a grooved part 21 formed by, for example, pressing the side part thereof from the outside to support the sealing assembly 16. The grooved part 21 is preferably formed circularly along the circumferential direction of the exterior housing body 15, and supports the sealing assembly 16 with the upper face of the grooved part 21.

The sealing assembly 16 has a stacked structure of a filter 22, a lower vent member 23, an insulating member 24, an upper vent member 25, and a cap 26 in this order from the electrode assembly 14 side. Each member constituting the sealing assembly 16 has, for example, a disk shape or a ring shape, and each member except for the insulating member 24 is electrically connected each other. The lower vent member 23 and the upper vent member 25 are connected each other at each of central parts thereof, and the insulating member 24 is interposed between each of the circumferential parts of the vent members 23 and 25. If the internal pressure of the battery increases with abnormal heat generation, for example, the lower vent member 23 breaks and the upper vent member 25 expands toward the cap 26 side to be separated from the lower vent member 23, resulting in cutting off of an electrical connection between the both members. If the internal pressure further increases, the upper vent member 25 breaks, and gas is discharged through an opening 26a of the cap 26.

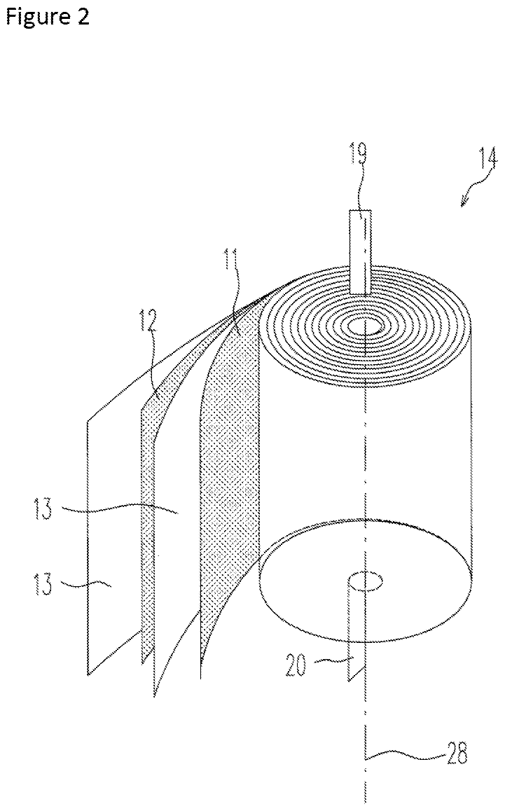

Next, the electrode assembly 14 will be described with reference to FIG. 2. FIG. 2 is a perspective view of the electrode assembly 14. As described above, the electrode assembly 14 has a wound structure in which the positive electrode 11 and the negative electrode 12 are spirally wound with the separator 13 interposed therebetween. Any of the positive electrode 11, the negative electrode 12, and the separator 13 is formed in a band shaped, and spirally wound around a winding core disposed along a winding axis 28 to be alternately stacked in the radial direction of the electrode assembly 14. In the radial direction, the winding axis 28 side is referred to as the inner peripheral side, and the opposite side is referred to as the outer peripheral side. In the electrode assembly 14, the longitudinal direction of the positive electrode 11 and negative electrode 12 corresponds to a winding direction, and the width direction of the positive electrode 11 and negative electrode 12 corresponds to an axial direction. The positive electrode lead 19 extends, on the upper end of the electrode assembly 14 toward the axial direction, from a substantial center between the center and the outermost circumference in the radial direction. The negative electrode lead 20 extends, on the lower end of the electrode assembly 14, toward the axial direction from near the winding axis 28.

For the separator 13, a porous sheet having an ion permeation property and an insulation property is used. Specific examples of the porous sheet include a fine porous thin film, a woven fabric, and a nonwoven fabric. As a material of the separator 13, an olefin resin such as polyethylene and polypropylene is preferable. A thickness of the separator 13 is, for example, 10 μm to 50 μm. The separator 13 has tended to be thinned as higher capacity and higher output of the battery. The separator 13 has a melting point of, for example, approximately 130° C. to 180° C.

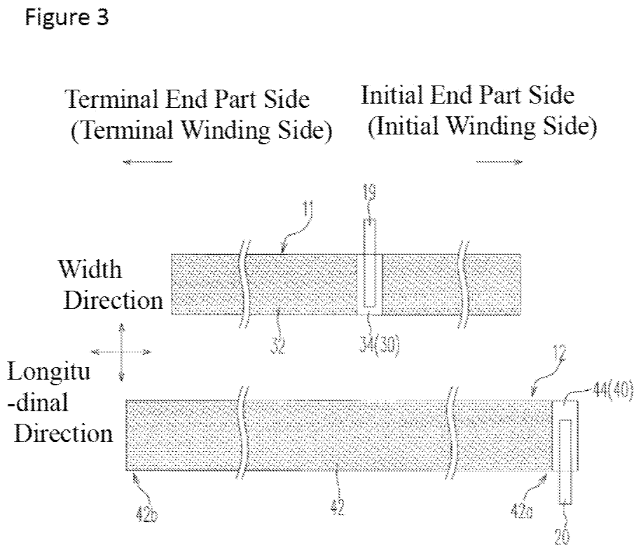

Next, FIG. 3 is a front view of the positive electrode 11 and negative electrode 12 constituting the electrode assembly 14. FIG. 3 illustrates the positive electrode 11 and the negative electrode 12 with an unwound state. As exemplified in FIG. 3, the negative electrode 12 is formed to be larger than the positive electrode 11 to prevent precipitation of lithium on the negative electrode 12 in the electrode assembly 14. Specifically, a length in the width direction (axial direction) of the negative electrode 12 is larger than a length in the width direction of the positive electrode 11. In addition, a length in the longitudinal direction of the negative electrode 12 is larger than a length in the longitudinal direction of the positive electrode 11. As a result, at least a portion on which the positive electrode mixture layer 32 of the positive electrode 11 is formed is disposed opposite to a portion on which negative electrode mixture layer 42 of the negative electrode 12 is formed with the separator 13 interposed therebetween when wound as the electrode assembly 14.

The positive electrode 11 has the band-shaped positive electrode current collector 30 and the positive electrode mixture layer 32 formed on the positive electrode current collector 30. The positive electrode mixture layer 32 is formed on at least one of the inner peripheral side and outer peripheral side of the positive electrode current collector 30.

For the positive electrode current collector 30, a foil of a metal, such as aluminum, a film in which such a metal is disposed on a surface layer thereof, and the like are used, for example. A preferable positive electrode current collector 30 is a foil of aluminum or of a metal mainly composed of an aluminum alloy. A thickness of the positive electrode current collector 30 is, for example, 10 μm to 30 μm.

The positive electrode mixture layer 32 is preferably formed on an entire region of both surfaces of the positive electrode current collector 30 except for a positive electrode exposed part 34, described later. The positive electrode mixture layer 32 preferably includes a positive electrode active material, a conductive agent, and a binder. The positive electrode mixture layer 32 is formed by applying a positive electrode mixture slurry including the positive electrode active material, the conductive agent, the binder, and a solvent such as N-methyl-2-pyrrolidone (NMP) on both the surfaces of the positive electrode current collector 30 to be dried. Then, the positive electrode mixture layer 32 is compressed.

Examples of the positive electrode active material may include a lithium-containing transition metal oxide containing a transition metal element such as Co, Mn, and Ni. The lithium-containing transition metal oxide is not particularly limited, and preferably a composite oxide represented by the general formula Li₁₊ₓMO₂ (in the formula, −0.2 <x≤0.2 and M includes at least one of the group consisting of Ni, Co, Mn, and Al).

Examples of the conductive agent included in the positive electrode mixture layer 32 may include carbon materials such as carbon black (CB), acetylene black (AB), Ketjenblack, and graphite.

Examples of the binder included in the positive electrode mixture layer 32 include fluororesins such as polytetrafluoroethylene (PTFE) and polyvinylidene fluoride (PVDF), polyacrylonitrile (PAN), a polyimide (PI), an acrylic resin, and a polyolefin resin. When the positive electrode mixture slurry is prepared in an aqueous solvent, styrene-butadiene rubber (SBR), nitrile rubber (NBR), CMC or a salt thereof, polyacrylic acid or a salt thereof, polyvinyl alcohol, and the like may be used. These materials may be used singly, and may be used in combination of two or more thereof. A content rate of the binder in the positive electrode mixture layer 32 is 0.5 mass % to 10 mass %, and preferably 1 mass % to 5 mass %.

On the positive electrode 11, the positive electrode exposed part 34 in which a surface of the positive electrode current collector 30 is exposed is provided. The positive electrode exposed part 34 is a portion to which the positive electrode lead 19 is connected and a portion in which a surface of the positive electrode current collector 30 is uncovered with the positive electrode mixture layer 32. The positive electrode exposed part 34 is formed to be wider in the longitudinal direction than the positive electrode lead 19. The positive electrode exposed part 34 is preferably provided on both surfaces of the positive electrode 11 to be stacked in the thickness direction of the positive electrode 11. The positive electrode lead 19 is bonded to the positive electrode exposed part 34 with, for example, ultrasonic welding.

In the example illustrated in FIG. 3, the positive electrode exposed part 34 is provided on the central part in the longitudinal direction of the positive electrode 11 and over an entire length in the width direction. The positive electrode exposed part 34 may be formed on the initial end part or terminal end part of the positive electrode 11, and is preferably provided at a position of substantially same distance from the initial end part and the terminal end part from a viewpoint of current collectability. The positive electrode lead 19 connected to the positive electrode exposed part 34 provided at such a position allows the positive electrode lead 19 to be disposed to project upward from the end surface in the width direction at a medial position in the radial direction of the electrode assembly 14 when wounded as the electrode assembly 14. The positive electrode exposed part 34 is provided by, for example, intermittent application in which the positive electrode mixture slurry is not applied on a part of the positive electrode current collector 30.

The negative electrode 12 has the band-shaped negative electrode current collector 40 and the negative electrode mixture layer 42 formed on both side surfaces of the negative electrode current collector 40. For the negative electrode current collector 40, a foil of a metal such as copper, a film in which such a metal is disposed on a surface layer thereof, or the like is used, for example. A thickness of the negative electrode current collector 40 is, for example, 5 μm to 30 μm.

The negative electrode mixture layer 42 is preferably formed on an entire region of both surfaces of the negative electrode current collector 40 except for a negative electrode exposed part 44, described later. The negative electrode mixture layer 42 preferably includes a negative electrode active material and a binder. The negative electrode mixture layer 42 is formed by applying a negative electrode mixture slurry including the negative electrode active material, the binder, and a solvent such as water on both the surfaces of the negative electrode current collector 40 to be dried. Then, the negative electrode mixture layer 42 is compressed.

In the example illustrated in FIG. 3, the negative electrode exposed part 44 is provided on the initial end part in the longitudinal direction of the negative electrode 12 and over an entire length in the width direction of the negative electrode current collector. The negative electrode exposed part 44 is a portion to which the negative electrode lead 20 is connected and a portion in which a surface of the negative electrode current collector 40 is uncovered with the negative electrode mixture layer 42. The negative electrode exposed part 44 is formed to be wider in the longitudinal direction than a width of the negative electrode lead 20. The negative electrode exposed part 44 is preferably provided on both surfaces of the negative electrode 12 to be stacked in the thickness direction of the negative electrode 12.

In the present embodiment, the negative electrode lead 20 is bonded to a surface on the inner peripheral side of the negative electrode current collector 40 with, for example, ultrasonic welding. One end part of the negative electrode lead 20 is disposed on the negative electrode exposed part 44, and the other end part extends downward from the lower end of the negative electrode exposed part 44.

The disposed position of the negative electrode lead 20 is not limited to the example illustrated in FIG. 3, and the negative electrode lead 20 may be provided only on the terminal end part of the negative electrode 12. Alternatively, the negative electrode lead 20 may be provided on the initial end part and terminal end part of the negative electrode 12. In this case, the current collectability is improved. The terminal end part of the negative electrode 12 may be electrically connected to the exterior housing body 15 without the negative electrode lead 20 by contacting the negative electrode exposed part 44 on the terminal end part of the negative electrode 12 with the inner peripheral face of the exterior housing body 15 (see FIG. 1). The negative electrode exposed part 44 is provided by, for example, intermittent application in which the negative electrode mixture slurry is not applied on a part of the negative electrode current collector 40.

The negative electrode active material is not particularly limited as long as it may reversibly occlude and release lithium (Li) ions, and for example, carbon materials such as natural graphite and artificial graphite, metals that form an alloy with lithium such as Si and Sn, or an alloy or oxide including them may be used.

The binder included in the negative electrode mixture layer 42 is typically made of a resin (resin binder), and examples thereof include fluororesins such as polytetrafluoroethylene (PTFE) and polyvinylidene fluoride (PVDF), polyacrylonitrile (PAN), a polyimide (PI), an acrylic resin, and a polyolefin resin. When the negative electrode mixture slurry is prepared in an aqueous solvent, styrene-butadiene rubber (SBR), nitrile rubber (NBR), polyacrylic acid or a salt thereof, polyvinyl alcohol, and the like may be used. As the binder, a rubber resin having a molecular structure repeating double bonds and single bonds, such as SBR and NBR, is preferable from the viewpoint of flexibility of the negative electrode 12. These materials may be used singly, and may be used in combination of two or more thereof. A content rate of the binder in the negative electrode mixture layer 42 is 0.5 mass % to 10 mass %, and preferably 1 mass % to 5 mass %.

In FIG. 3, the initial end part 42a of the negative electrode mixture layer 42 is a portion adjacent to the negative electrode exposed part 44. Meanwhile, the terminal end part 42b of the negative electrode mixture layer 42 is identical to the terminal end part of the negative electrode 12. The negative electrode mixture layer 42 is continuously present from the initial end part 42a to the terminal end part 42b.

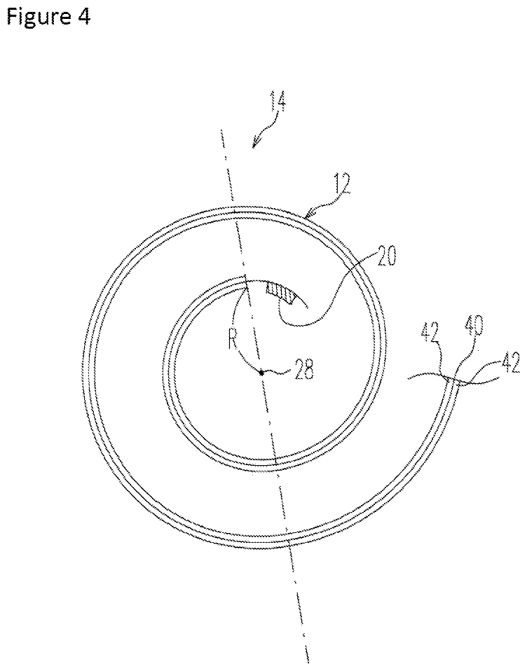

Next, the winding radius of the negative electrode 12 near the initial end part of the negative electrode mixture layer 42 will be described with reference to FIG. 4. FIG. 4 is a radial sectional view of the negative electrode 12 near the winding axis 28 of the electrode assembly 14 of an example of an embodiment. Description of the positive electrode 11 and the separator 13 is omitted in FIG. 4.

The winding radius of the innermost circumference of the negative electrode 12 in the electrode assembly 14 is, for example, 1 mm to 5 mm. The innermost circumference of the negative electrode 12 is a circumference portion initiated from the initial end of the negative electrode 12. The winding radius of the innermost circumference of the negative electrode 12 is specified with a distance R between the winding axis 28 and the negative electrode 12. A smaller R is preferable for increasing the capacity of the secondary battery 10, but cracking and peeling tend to occur on the negative electrode mixture layer 42. In contrast, the present disclosure prevents such cracking and peeling on the negative electrode mixture layer 42, and thereby R is preferably 1 mm to 5 mm. Such a constitution allows the secondary battery 10 to have a high capacity. The winding radius of the innermost circumference of the negative electrode 12 may be regulated with a radius of the winding core used for winding the positive electrode 11, the negative electrode 12, and the separator 13.

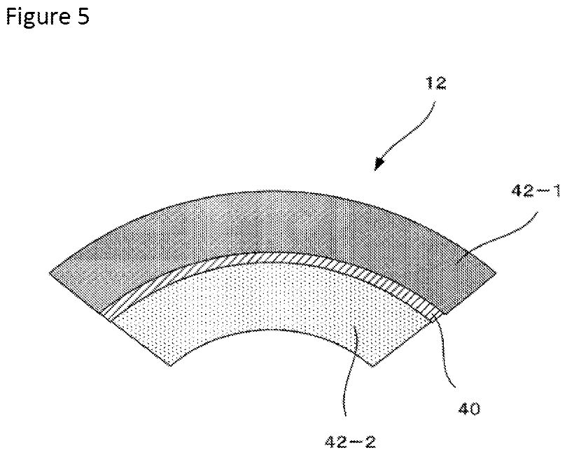

FIG. 5 is a partially enlarged view of a radial cross section of the negative electrode 12. As illustrated, an outer negative electrode mixture layer 42-1 is positioned on the outer peripheral side of the negative electrode current collector 40, and an inner negative electrode mixture layer 42-2 is positioned on the inner peripheral side of the negative electrode current collector 40. With winding the electrode assembly 14, the outer negative electrode mixture layer 42-1 is elongated, and the inner negative electrode mixture layer 42-2 is compressed. In particular, an electrode near the winding core has a small radius of curvature, and the outer negative electrode mixture layer 42-1 is elongated to tend to cause cracking and peeling from the negative electrode current collector 40 due to repeated expansion and contraction with charge and discharge, leading to lowering of the capacity maintenance rate. Meanwhile, in the inner negative electrode mixture layer 42-2, a gap for moving the electrolyte liquid shrinks and the electrode reaction becomes ununiform to tend to increase an internal resistance.

In the negative electrode 12 of the non-aqueous electrolyte secondary battery of the present disclosure, the inner negative electrode mixture layer 42-2 includes a binder having a relatively low degree of swelling, and the outer negative electrode mixture layer 42-1 includes a binder having a relatively high degree of swelling. For example, the degree of swelling of the binder included in the inner negative electrode mixture layer 42-2 is 100 to 150%, and the degree of swelling of the binder included in the outer negative electrode mixture layer is 150 to 250%.

For example, in a styrene-butadiene rubber (SBR), adding acrylonitrile as its constituent monomer increases the degree of swelling. Accordingly, when the styrene-butadiene rubber (SBR) is used for the binder, regulating a content of acrylonitrile may regulate the degree of swelling of the binder. In addition, since the degree of swelling differs depending on a type of the binder as described in Patent Literature 2, binders having different degrees of swelling may be used.

Here, a binder having a high degree of swelling extends with incorporating the electrolyte liquid, but because of its large particle diameter, the passage for the electrolyte liquid between the active materials shrinks with adhering to the active material, leading to lowered dispersity of lithium ions. Meanwhile, a binder having a low degree of swelling has low expansion and is unlikely to extend with incorporating the electrolyte liquid, but because of its small particle diameter, the passage for the electrolyte liquid is hardly blocked even with adhering to the active material, and the dispersity of lithium ions is not lowered.

Therefore, the inner negative electrode mixture layer 42-2 including the binder having a low degree of swelling may allow the inner negative electrode mixture layer 42-2 to achieve the dispersity of Li ions with wound. In addition, the outer negative electrode mixture layer 42-1 including the binder having a high degree of swelling, which allows the binder to follow the extension between the active materials when it is wound, inhibits the occurrence of cracking and maintains the adhesion of the outer negative electrode mixture layer 42-1 to the negative electrode current collector.

As above, the present disclosure may uniform the electrode reaction on the inner negative electrode mixture layer 42-2, and may inhibit the peeling of the outer negative electrode mixture layer 42-1 to improve the cycle characteristics.

### EXAMPLES

The present disclosure will be further described below with Examples, but the present disclosure is not limited to these Examples.

### Example 1

[Production of Positive Electrode]

Mixing of 95 parts by mass of LiNi_{0.8}Co_{0.15}Al_{0.05}O₂, 2.5 parts by mass of acetylene black (AB), and 2.5 parts by mass of polyvinylidene fluoride (PVDF) having an average molecular weight of 1.1 million was performed, and an appropriate amount of N-methyl-2-pyrrolidone (NMP) was added thereto to prepare a positive electrode mixture slurry with 70 mass % solid content. Then, this positive electrode mixture slurry was applied on both surfaces of a band-shaped positive electrode current collector made with an aluminum foil having a thickness of 15 μm, and the applied film was heated at 100° C. to 150° C. to be dried. The dried applied film was compressed by using a roller, and then cut to a predetermined electrode size to produce a positive electrode in which a positive electrode mixture layer was formed on both the surfaces of the positive electrode current collector. A positive electrode exposed part where no positive electrode mixture layer was present and the surface of the positive electrode current collector was exposed was provided at a substantially central part in the longitudinal direction of the positive electrode, and a positive electrode lead made with aluminum was welded with the positive electrode exposed part.

[Production of Negative Electrode]

Mixing of 95 parts by mass of graphite, 5 parts by mass of an oxide of Si (SiO), and 1 part by mass of carboxymethyl cellulose (CMC) as a thickener, with an appropriate amount of water was performed. Into this mixture, 1.5 parts by mass of a styrene-butadiene rubber (SBR) having a degree of swelling to a non-aqueous solvent of 250% was mixed to prepare a first negative electrode mixture slurry. Separately, 95 parts by mass of graphite, 5 parts by mass of an oxide of Si (SiO), and 1 part by mass of carboxymethyl cellulose (CMC) as a thickener, with an appropriate amount of water were mixed to obtain a mixture same as above. Into this mixture, 1.5 parts by mass of a styrene-butadiene rubber (SBR) having a degree of swelling to a non-aqueous solvent of 100% was mixed to prepare a second negative electrode mixture slurry. Then, the first negative electrode mixture slurry and the second negative electrode mixture slurry were set into a die coater, the first negative electrode mixture slurry was applied on one surface of a band-shaped negative electrode current collector made with a copper foil, the second negative electrode mixture slurry was applied on the other surface, and then the applied film was dried. The dried applied film was compressed by using a roller, and then cut to a predetermined electrode size to produce a negative electrode in which an outer negative electrode mixture layer was formed on one surface of the negative electrode current collector and an inner negative electrode mixture layer was formed on the other surface. A negative electrode exposed part where no negative electrode mixture layer was present on the initial end part and the surface of the negative electrode current collector was exposed was provided, and a negative electrode lead made with nickel/cupper was welded with the negative electrode exposed part.

[Preparation of Electrolyte]

Into a mixed solvent of ethylene carbonate (EC), dimethyl carbonate (DMC), and diethyl carbonate (DEC), LiPF₆ as a Li salt was dissolved to prepare an electrolyte.

[Regulation of Degree of Swelling of Binder]

As described above, in a styrene-butadiene rubber (SBR), adding acrylonitrile as its constituent monomer increases the degree of swelling. Thus, an amount of acrylonitrile added was regulated to regulate the degree of swelling of the binder.

[Evaluation Method of Degree of Swelling of Binder]

A binder dispersed in a solvent was dried to produce a film, and this film was immersed in the electrolyte liquid (EC/DMC/DEC+Li salt) for 24 hours to evaluate a degree of swelling with masses before and after the immersion.

Degree of Swelling (%) =(Mass of Film after Immersion/Mass of Film before Immersion)×100

[Production of Electrode Assembly]

The positive electrode and the negative electrode were wound with a separator composed of a fine porous film made with polyethylene having a thickness of 20 μm with a winding core having a radius of curvature of 1.5 mm, and a tape was attached to the outermost circumference surface to produce a wound electrode assembly. In this time, the winding was performed so that a first negative electrode mixture layer on which the first negative electrode mixture slurry was applied became the outer side, and a second negative electrode mixture layer on which the second negative electrode mixture slurry was applied became the inner side.

[Production of Cylindrical Secondary Battery]

Each insulating plate was disposed on the upper and lower sides of one electrode assembly, and the electrode assembly was housed in a bottomed cylindrical exterior housing body. Then, a negative electrode lead was welded with an inner bottom part of the exterior housing body, and a positive electrode lead was welded with a sealing assembly. Thereafter, the electrolyte was injected inside the exterior housing body with a decompression method, and then an opening end of the exterior housing body was sealed by calking with a gasket to the sealing assembly to produce a cylindrical secondary battery. The produced cylindrical secondary battery had a height of 65 mm, a diameter of 18 mm, and a designed battery capacity of 3000 mAh.

### Example 2

Example 2 was same as Example 1 except that the degree of swelling of the binder in the first negative electrode mixture layer was changed to 150%.

### Comparative Example 1

Comparative Example 1 was same as Example 1 except that the degree of swelling of the binder in the first negative electrode mixture layer was changed to 100%, and the degree of swelling of the binder in the second negative electrode mixture layer was changed to 250%.

### Comparative Example 2

Comparative Example 2 was same as Example 1 except that the degree of swelling of the binder in the second negative electrode mixture layer was changed to 250%.

### Comparative Example 3

Comparative Example 3 was same as Example 1 except that the degree of swelling of the binder in the first negative electrode mixture layer was changed to 100%.

### Comparative Example 4

Comparative Example 4 was same as Example 1 except that the degree of swelling of the binder in the first negative electrode mixture layer was changed to 300%.

[Measurement of Capacity Maintenance Rate with Charge-Discharge Cycle]

Under an environment temperature at 25° C., the non-aqueous electrolyte secondary battery of each Example and each Comparative Example was charged at a constant current (current 0.3 It=900 mA, termination voltage 4.2 V), and then charged at a constant voltage (voltage 4.2 V, termination current 150 mA). Then, the battery was discharged at a constant current, at a current value of 900 mA until a termination voltage of 2.75 V. This charge and discharge were specified as one cycle, and 300 cycles were performed. Then, a capacity maintenance rate with the charge-discharge cycle of the non-aqueous electrolyte secondary battery of each Example and each Comparative Example was determined with the following formula to evaluate the cycle characteristics. It is to be noted that It (A)=Rated Capacity (Ah)/1 (h).

Capacity Maintenance Rate=(Discharge Capacity at 300th Cycle/Discharge Capacity at 1st Cycle)×100

Table 1 shows the evaluation results in Examples 1 and 2 and Comparative Examples 1 to 4.

TABLE 1

| | Degree of swelling of binder (%) | | Capacity |
|---|---|---|---|
| — | Outer mixture | Inner mixture | maintenance |
| — | layer | layer | rate (%) |
| Example 1 | 250% | 100% | 90% |
| Example 2 | 150% | 100% | 86% |
| Comparative | 100% | 250% | 67% |
| Example 1 | | | |
| Comparative | 250% | 250% | 76% |
| Example 2 | | | |
| Comparative | 100% | 100% | 75% |
| Example 3 | | | |
| Comparative | 300% | 100% | 74% |
| Example 4 | | | |

Example 1, which had the capacity maintenance rate as high as 90%, was considered to have sufficient ion dispersity in the inner negative electrode mixture layer and to inhibit the peeling of the outer negative electrode mixture layer. In Example 2, the degree of swelling of the binder in the outer negative electrode mixture layer was slightly lowered to weaken the effect of peeling inhibition compared with Example 1. Comparative Example 1 was considered to have lower ion dispersity in the inner negative electrode mixture layer to increase the peeling of the outer negative electrode mixture layer. In Comparative Example 2, the peeling of the outer negative electrode mixture layer must be inhibited compared with Comparative Example 1, but the ion dispersity in the inner negative electrode mixture layer was considered to be lowered compared with Example 1. In Comparative Example 3, it was considered that the peeling of the outer negative electrode mixture layer was not inhibited compared with Example 1. In Comparative Example 4, a degree of swelling of the outer negative electrode mixture layer was 300%, which was exceedingly high, and the outer negative electrode mixture layer was considered to be peeled. Therefore, the outer negative electrode mixture layer preferably includes a binder having a degree of swelling of 150 to 250%. The degree of swelling of the binder in the inner negative electrode mixture layer is not particularly limited as long as it is lower than the degree of swelling of the binder in the outer negative electrode mixture layer, and the inner negative electrode mixture layer preferably includes a binder having a degree of swelling of 100 to 150%.

From the above evaluation results, it has been confirmed that regulating the degrees of swelling of the binders in the inner negative electrode mixture layer and outer negative electrode mixture layer within the appropriate range, as in Examples 1 and 2, may improve the ion dispersity in the inner negative electrode mixture layer, and inhibit the cracking and peeling of the outer negative electrode mixture layer to improve the cycle characteristics.

### REFERENCE SIGNS LIST

10 Secondary battery, 11 Positive electrode, 12 Negative electrode, 13 Separator, 14 Electrode assembly, 15 Exterior housing body, 16 Sealing assembly, 17, 18 Insulating plate, 19 Positive electrode lead, 20 Negative electrode lead, 21 Grooved part, 22 Filter, 23 Lower vent member, 24 Insulating member, 25 Upper vent member, 26 Cap, 26a Opening, 27 Gasket, 28 Winding axis, 30 Positive electrode current collector, 32 Positive electrode mixture layer, 34 Positive electrode exposed part, 40 Negative electrode current collector, 42 Negative electrode mixture layer, 42-1 Outer negative electrode mixture layer, 42-2 Inner negative electrode mixture layer, 44 Negative electrode exposed part.

1. A non-aqueous electrolyte secondary battery, comprising:
an electrode assembly in which a band-shaped positive electrode and a band-shaped negative electrode are wound with a separator interposed therebetween; and
an exterior housing body that houses the electrode assembly, wherein
the negative electrode has a negative electrode current collector, and a negative electrode mixture layer formed on both side surfaces of the negative electrode current collector and including at least a negative electrode active material and a binder,
the negative electrode mixture layer has an outer negative electrode mixture layer positioned on an outer peripheral side of the negative electrode current collector, and an inner negative electrode mixture layer positioned on an inner peripheral side of the negative electrode current collector,
a degree of swelling of the binder included in the outer negative electrode mixture layer is higher than a degree of swelling of the binder included in the inner negative electrode mixture layer, and
the outer negative electrode mixture layer includes a binder having a degree of swelling of 150 to 250%.

2. The non-aqueous electrolyte secondary battery according to claim 1, wherein the inner negative electrode mixture layer includes a binder having a degree of swelling of 100 to 150%.

3. The non-aqueous electrolyte secondary battery according to claim 1, wherein the binder includes a styrene-butadiene rubber having acrylonitrile as a constituent monomer, and a content of acrylonitrile in the styrene-butadiene rubber included in the outer negative electrode mixture layer is higher than a content of acrylonitrile in the styrene-butadiene rubber included in the inner negative electrode mixture layer.

4. A negative electrode for a non-aqueous electrolyte secondary battery, being used for a non-aqueous electrolyte secondary battery comprising an electrode assembly in which a band-shaped positive electrode and a band-shaped negative electrode are wound with a separator interposed therebetween, and an exterior housing body that houses the electrode assembly, the negative electrode having:
a negative electrode current collector; and
a negative electrode mixture layer formed on both side surfaces of the negative electrode current collector and including at least a negative electrode active material and a binder,
the negative electrode mixture layer has an outer negative electrode mixture layer positioned on an outer peripheral side of the negative electrode current collector, and an inner negative electrode mixture layer positioned on an inner peripheral side of the negative electrode current collector,
a degree of swelling of the binder included in the outer negative electrode mixture layer is higher than a degree of swelling of the binder included in the inner negative electrode mixture layer, and
the outer negative electrode mixture layer includes a binder having a degree of swelling of 150 to 250%.
